(19) United States
(12) Patent Application Publication
(10) Pub. No.: US 2012/0254026 A1
(43) Pub. Date: Oct. 4, 2012

(54) METHOD AND APPARATUS OF PERFORMING EXPEDITE MONETARY EXCHANGE PROCEDURES

(75) Inventors: Carey Lotzer, Sachse, TX (US); Jon Mosier, Coppell, TX (US)

(73) Assignee: TOUCHPAY HOLDINGS LP, Irving, TX (US)

(21) Appl. No.: 13/244,333

(22) Filed: Sep. 24, 2011

Related U.S. Application Data
(60) Provisional application No. 61/463,720, filed on Feb. 23, 2011.

(51) Int. Cl. G06Q 40/02; G06Q 20/34; G06Q 20/10

(52) U.S. Cl. 705/41; 705/39

(57) ABSTRACT

A method, computer program product, circuitry and apparatus for providing integrated user monetary transactions are disclosed. One example method may include managing a number of different device interfaces via a management interface, the device interfaces configured to communicate interactively with a user. The method may also include communicating commands with the management interface via an application layer interface, comprising a memory and processor, the commands being communicated responsive to the user's interactive communication with the device interfaces, and receiving user input commands corresponding to the user's actions via the device interfaces.

### CROSS REFERENCE TO RELATED APPLICATIONS

The present invention claims benefit to provisional application No. U.S. 61/463,720, entitled “Advance Payment System”, filed on Feb. 23, 2011, the entire contents of which are hereby incorporated by reference.

### FIELD OF THE INVENTION

The present invention is related to advanced mechanical, electrical and software capabilities related to multiple layers of discrete processes used for the purpose of receiving one or more forms of payment, either full or partial, through the use of one or more hardware components.

The instant application provides for the data collection and payment process, the software and hardware interactivity, as well as the technology used to apply a payment to a wired or wireless network connection or locally if the network is not available.

### BACKGROUND OF THE INVENTION

Current computer-based payment systems use a proprietary system of hardware and software to collect a user's password, receive a payment by cash, credit card, or check and deposit the payment to the user's account. Existing systems may provide a touch-screen interface which allows the user to enter their account credentials, such as a password, which may be authenticated either by a bank card or a personal identification number stored on the bank's server. Once the user's account has been verified, they are able to make a payment.

If a payment is made by cash, the dollars are generally placed in an envelope which is stored in the teller unit until it is recovered and validated by a banker.

Coins present a whole new array of problems. Because of the weight of coins in any denomination and the attendant not wanting to handle coins, users are discouraged from placing these into the envelope as part of their deposit. Many times coins must be deposited in-person where the attendant verifies the deposit at the time the coins are received or by using a cost prohibitive electronic counting unit which is generally not connected to the user's account but produces a deposit slip which is then taken to the attendant to add to their account manually.

### SUMMARY OF THE INVENTION

The instant invention provides novel implementations of processing deposits by integrating and consolidating the processes necessary for receiving the user's payment credentials, payment information, and having the ability to simultaneously receive cash, credit and coin forms of payment as well as providing the ability to validate the cash and coin payments without the need for a network connection.

In addition, the instant invention may also provide search capability as well as one or more methods of verification of the user account information that they have entered, and whether such user account information is or is not correct with or without access to a network connection.

In addition, the instant invention may also provide one or more methods to protect the account guarantor by receiving user payment information, validating credit card payments in real-time, allowing the user to verify the deposit account information, recording a video of the transaction, taking one or more pictures of the user as the deposit is being made, and validating the funds, either cash or coin, being placed toward the account.

The hardware components of the instant invention may include the use of none, one or more touch-screens, credit card units, cash validation units, coin validation units, cameras, speakers, amplifiers, printers, network devices, serial connectivity devices, storage devices, computer processing devices, remote network access devices, encrypted or clear-text keypads, trackballs, scanners, mobile devices, wireless devices as well as other devices.

The instant invention may operate using an attendant or operate unattended where the user is responsible for entering the deposit information and providing the funds for the deposit.

The instant invention may employ one or more methods of delivering deposit information for the account either in real-time as the deposit is being made, or in a batch mode. The system may also transmit one or more correspondence once a deposit has been made or if one or more errors occur.

One or more fee schedules may be applied to the deposit. Algorithms may be used within the instant invention to determine the value of the fees based on either a fixed amount, a varying amount based on the deposit being received, or an amount the user advises before they begin the deposit.

The instant invention may provide one or more applications and/or accounts to which the user may apply their deposit. For example, phone payments, utility payments, general spending account payments, as well as other payments and accounts. Payments may also be applied to cards or other devices which may be used as alternative methods of payment, for example, at retail outlets or services.

The instant invention may use configurable parameters which can be changed to suit the needs of one or more locations. For example, the configuration may contain the location's name, the payment structure, the hardware processes being used and well as services that may be supported. As service offering may change, the configuration may allow the services to be turned off, turned on or re-configured.

Once a new copy of the software program of the instant invention is to be installed in a new location, the base unit may be copied and only one or more configuration changes may be required to suit the needs of the new location.

The software processes and data related to the instant invention may be used, removed, added or changed locally using the interfaces provided, either hardware and/or software, using proximity communication devices or remotely over one or more wired or wireless network connections.

### BRIEF DESCRIPTION OF THE DRAWINGS

FIG. 1 shows an example of a payment or deposit screen where one or more applications may be selected, according to example embodiments.

FIG. 2 shows an example of a payment or deposit screen where the user's information is entered, according to example embodiments.

FIG. 3 shows an example of a payment or deposit screen where the account information is searched, according to example embodiments.

FIG. 4 shows an example of a payment or deposit screen where the payment or deposit is being received, according to example embodiments.

FIG. 5 shows an example of the receipt produced once the deposit has been made, according to example embodiments.

FIG. 6 shows an example of the process configuration for the system including some of the hardware components, according to example embodiments.

FIG. 7 shows an example of the payment or deposit system connected to a network, according to example embodiments.

FIG. 8 shows an example of the communications data set for a credit card structure, according to example embodiments.

FIG. 9 shows an example of the communications data set for a driver license structure, according to example embodiments.

FIG. 10 shows an example of the communications data set for a cash structure, according to example embodiments.

FIG. 11 shows an example of the communications data set for a coin structure, according to example embodiments.

FIG. 12 shows an example of the power and ground connections of the coin machine, interface board, and controller board.

FIG. 13 shows the circuitry of the function UnitOn that is used to turn the coin machine off and on.

FIG. 14 shows the circuitry of the function MotorOn that is used to turn the motor of the coin machine off and on.

FIG. 15 shows the circuitry of the function CntrClr that is used to clear the coin counter.

FIG. 16 shows the circuitry of the function UnitState that is used to read if the machine is turned on or off.

FIG. 17 shows the circuitry of the function MotorState that is used to read if the motor i turned on or off.

FIG. 18 shows the circuitry of the coin counter sensing a penny.

FIG. 19 shows the circuitry of the coin counter sensing a nickel.

FIG. 20 shows the circuitry of the coin counter sensing a dime.

FIG. 21 shows the circuitry of the coin counter sensing a quarter.

FIG. 22 shows the circuitry of the coin counter sensing a dollar.

FIG. 23 shows the circuitry of how the interface board is connected to the controller board.

FIG. 24 shows the circuitry of how the magnetic sensor is connected to the controller board.

FIG. 25 shows an example method of operation, according to example embodiments.

### DETAILED DESCRIPTION OF THE INVENTION

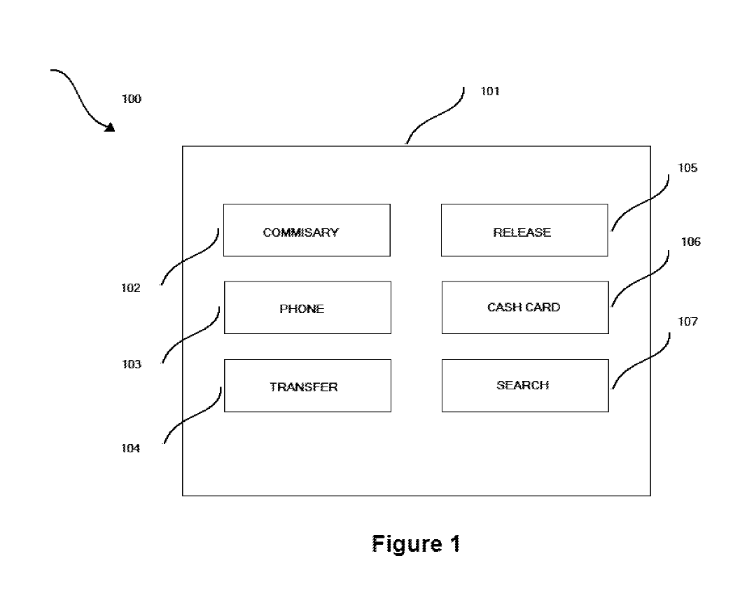

Referring to FIG. 1, an example of a payment or deposit screen 101 used in a system 100, is shown. Between the screen 101 and the instant system 100 is shown an example series of buttons 102 through 107 which operate as entry points into the one or more applications available to the user. For example, the user could press the commissary button 102 to access the commissary application. Once the commissary button 102 has been pressed, the screen 101 may change to the commissary deposit screen (not shown). The commissary deposit screen may provide a list of options for the user to select in order to access payment deposit and withdrawal options.

Other applications may be selected, such as a phone, for example, by pressing on the respective buttons, such as phone button 103, as this is just an example of the various combinations available on the screen 101. Other example buttons include a transfer button 104, a release button 105, a cash card button 106 and a search button 107. These options provide a user with access to various monetary transaction related options.

The search button 107 has been provided to show that a button may even lead to a point which is considered to be the middle of a given application. For example, if the search button 107 has been pressed, the system 100 could launch into the search screen 101 which allows the user to find the account using the person's name and/or birth date.

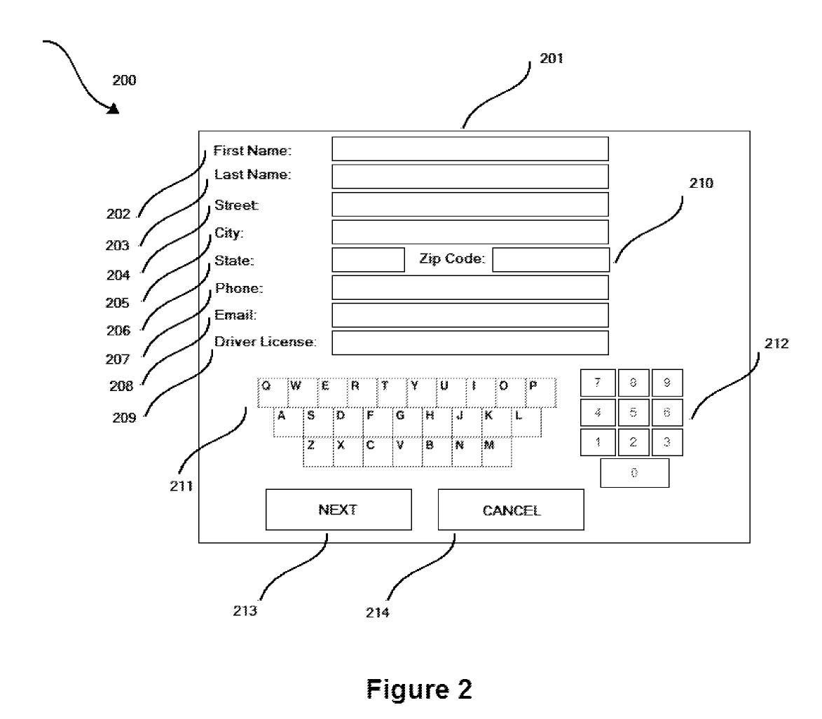

Referring now to FIG. 2, an example of a payment or deposit screen 201 is illustrated where the user may be asked to enter their personal information. This information may be used to contact the user if a payment fails for some reason. The screen 201 may include several items which may include, for example, first name 202, last name 203, street 204, city 205, state 206, zip code 210, phone number 207, email 208, and a driver's license 209. The user may not need to enter this information if they decide to swipe their driver license. If this method has been used, the system may receive the information from the driver license and use it instead to populate the user information screen 201. The screen 201 may have include other items including a soft keyboard 211 and a soft numeric keypad 212. In order to navigate to the next screen, the next button 213 may be available to the user, as is the cancel button 214 which may be used if the user wishes to cancel the transaction.

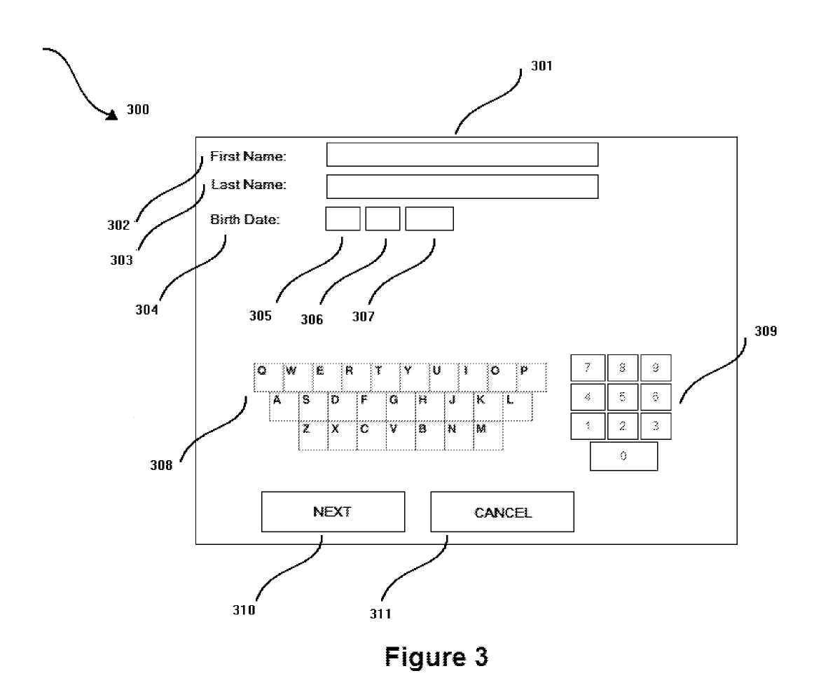

Referring now to FIG. 3, an example of a payment or deposit screen 301 used in a system 300 is shown where the user may search for the account information which may include the first name 302, the last name 303, the birth month 305, the birth day 306, and the birth year 307. The screen 301 may provide other items including a soft keyboard 308 and a soft numeric keypad 309. In order to navigate to the next screen, the next button 310 may be available to the user, as is the cancel button 311 which may be used if the user wishes to cancel the transaction.

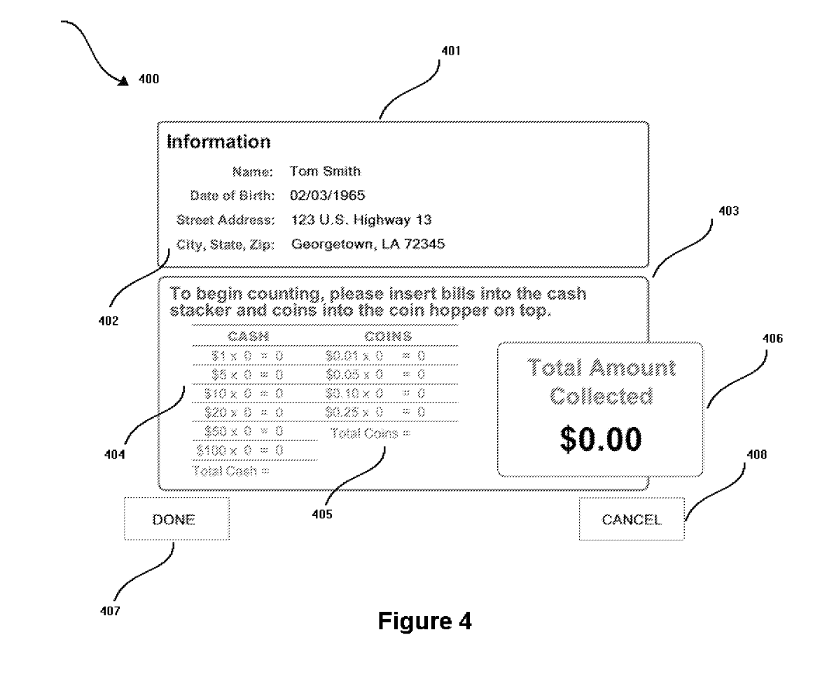

Referring now to FIG. 4, an example of a payment or deposit screen 401 used in a 400 is shown where the user may see the funds they are depositing being counted in real-time during a deposit transaction. The screen may include multiple sections which could include the information deposit screen section 401 and the count section 403. The account name, birth date, address information as well as other items may appear in the information section 401 shown using the information text 402.

The count section 403 may be composed of several rows and columns which may include a cash column 404 and a coin column 405. The cash column 404 may include a break down of each denomination. In the figure, the cash column 404 includes a separate view for $1, $5, $10, $20, $50, and $100 and may include other denominations of dollars. The coin column 405 may include denominations such as $0.01, $0.05, $0.10, $0.25, $0.50, $1.00, as well as other coin denominations.

The total section 406 may show the total amount, by adding all of the counted values. This may be done at the end of the transaction or while the denominations are being counted.

In order to finish the transaction or navigate to the next screen, the done button 407 may be available to the user, as is the cancel button 408 which may be used if the user wishes to cancel the transaction.

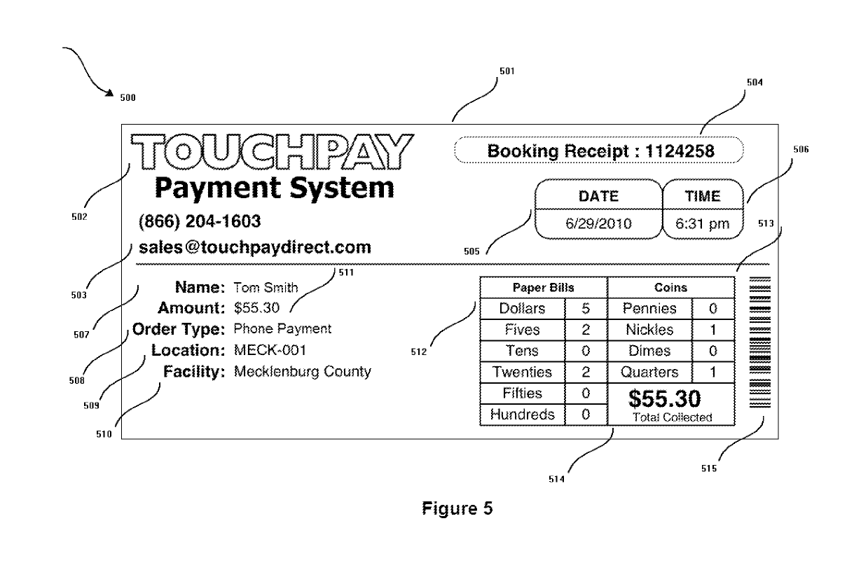

Referring now to FIG. 5, an example of a payment or deposit receipt 501 used in a system 500 is shown. The receipt 501 may include several portions of information. The company logo 502 and the company contact information 503 may appear on the receipt 501. The receipt type and number 504 may appear on the receipt 501, also, as well as the date 505 and the time of the transaction 506. The account information, including the name 507, the amount 511, the order type 508, the location code 509 and the facility 510 may also appear on the receipt 501, as well as other items.

Customized data, such as the company logo 502, the company contact information 503 may be stored in a metadata associated with all transactions conducted by the system 500 and the specific banking institution being contacted to upload accepted and counted monetary funds. The customized data may be part of the total data transferred from the financial institution to the user terminal system of FIGS. 1-5. For example, the user interface of system 500 may receive user submitted dollars and coins and provide an interactive counting and tallying operation that accepts the funds via a fund transfer interface. Once the funds are received and tallied, the user may view the total amount and accept the details of the counting procedure. The system 500 may then connect to the remote financial institution via a fax, phone call, e-mail, electronic wire, secure data connection, etc.

The system 500 may provide the secure user credentials (e.g., password) during the communication. The financial institution may then retrieve the user account information from a database and apply the funds to the user's account. In response, the financial institution may then send a confirmation back to the system 500 that includes an updated account balance and confirmation number. Certain metadata associated with the transaction, such as bank logo, date, transaction number, generic messages (“Thanks for banking with “ACME Bank Inc.”, etc.) may be appended to the confirmation data and received by the system 500. The metadata may be extracted and combined with the transaction data and either displayed on the user's display screen or provided as data on a printed receipt accessed provided to the user.

The receipt may also have a monetary section 513 which may include columns for the bills 512 and a column for the coins 514.

The bill column 512 may include counts of the bills, separated by their respective denominations, and may include separate totals for each denomination.

The coin column 514 may include counts of the coins, separated by their respective denominations, and may include separate totals for each denomination.

The receipt 501 may also include a bar code 515 or other item which may be used to track the receipt 501. Additional items may be included on the receipt 501 used for tracking purposes.

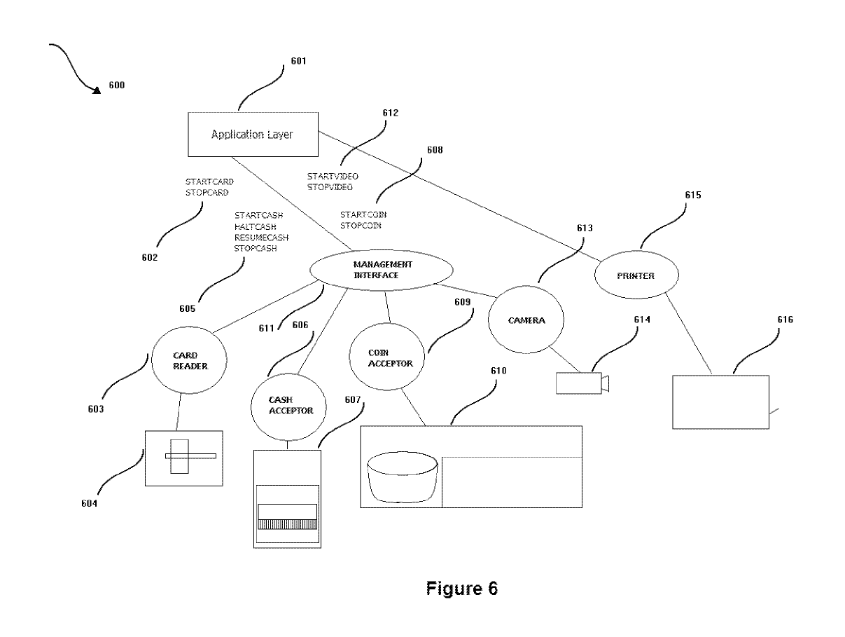

Referring now to FIG. 6, an example of a process configuration for one or more devices used in a system 600 is shown. The application layer 601 is communicatively coupled to the management interface 611 and further communications between the application layer 601 and the management interface 611 and the management interface 611 to the application layer 601 through messages and/or commands are conducted. Examples of the communications may include STARTCARD, STOPCARD 602, STARTCASH, HALTCASH, RESUMECASH, STOPCASH 605, STARTVIDEO, STOPVIDEO 612, STARTCOIN, STOPCOIN 608, among others. The management interface 611 further communicatively coupled to one or more hardware interfaces such as the card reader interface 603, the cash acceptor interface 606, the coin acceptor interface 609, the camera interface 613, among others not shown. Each respective hardware interface is also communicatively coupled to one or more hardware devices. In this example, the card reader interface 603 is communicatively coupled to the card reader hardware 604; the cash acceptor interface 606 is communicatively coupled to the cash acceptor hardware 607; the coin acceptor interface 609 is communicatively coupled to the coin acceptor hardware 610; the camera interface 613 is communicatively coupled to the camera hardware 614, among others not fully shown.

The application layer 601 may also be connected to more interfaces or other devices directly such as a printer interface 615 which is communicatively coupled to a printer hardware 616, among other devices and software or hardware interfaces not fully shown.

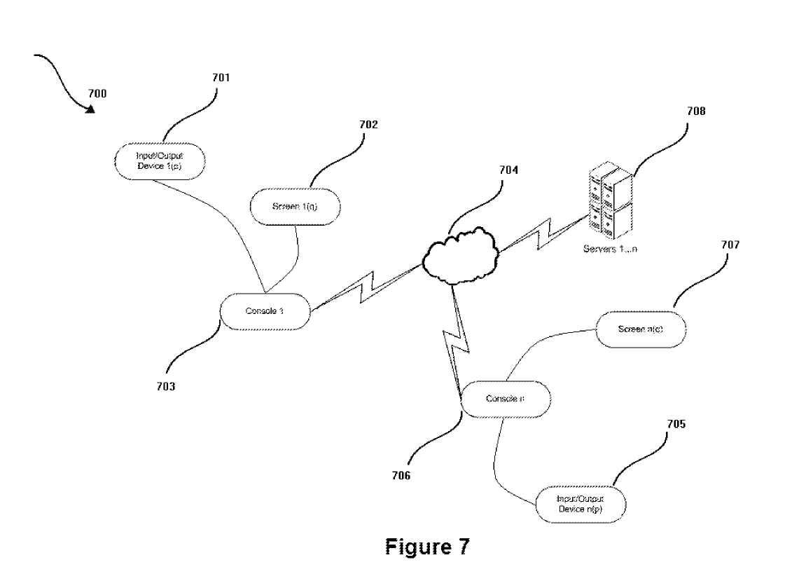

Referring now to FIG. 7, an example of a payment or deposit system connected to a network used in a system 700 is shown. The input/output devices and interfaces 701 are communicatively coupled to the one or more computing units 703 and may be communicatively coupled to none or more screens 702. The one or more computing units 703 may be further communicatively coupled to a network 704 and may be communicatively coupled to none or more servers 708 as well as being communicatively coupled to none or more remote computing units 706 where the remote input/output devices and interfaces 705 may be communicatively coupled to none or more computing units 706, which may be further communicatively coupled to none or more screens 707.'

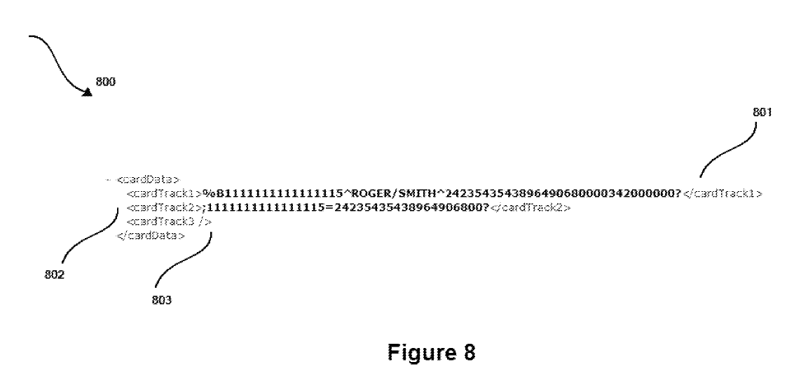

Referring now to FIG. 8, an example of a payment or deposit card interface used for communication between the application layer 601 previously described in FIG. 6 and underlying interface services through the management interface 611 and further through the one or more interfaces such as the card reader interface 603 among others not fully shown is illustrated in a system 800. The system 800 includes data in the cardTrack1 field 801, the cardTrack2 field 802, and the cardTrack3 field 803.

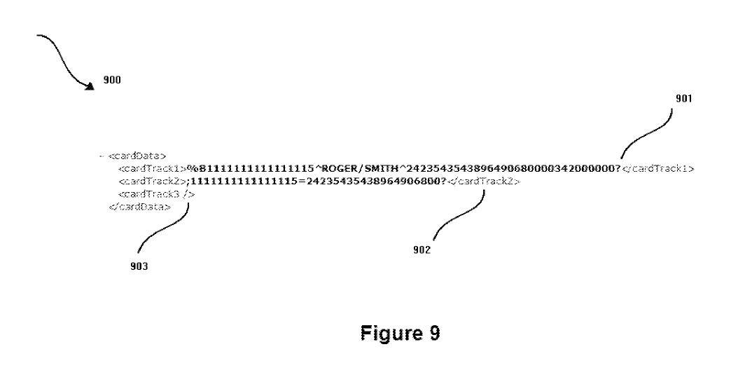

Referring now to FIG. 9, an example of a driver license card interface used for communication between the application layer 601 previously described in FIG. 6 and underlying interface services through the management interface 611 and further through the one or more interfaces such as the card reader interface 603 among others not fully shown (used in a conventional system 900, not fully shown) is described. The system 900 including data in the cardTrack1 field 901, the cardTrack2 field 902, and the cardTrack3 field 903.

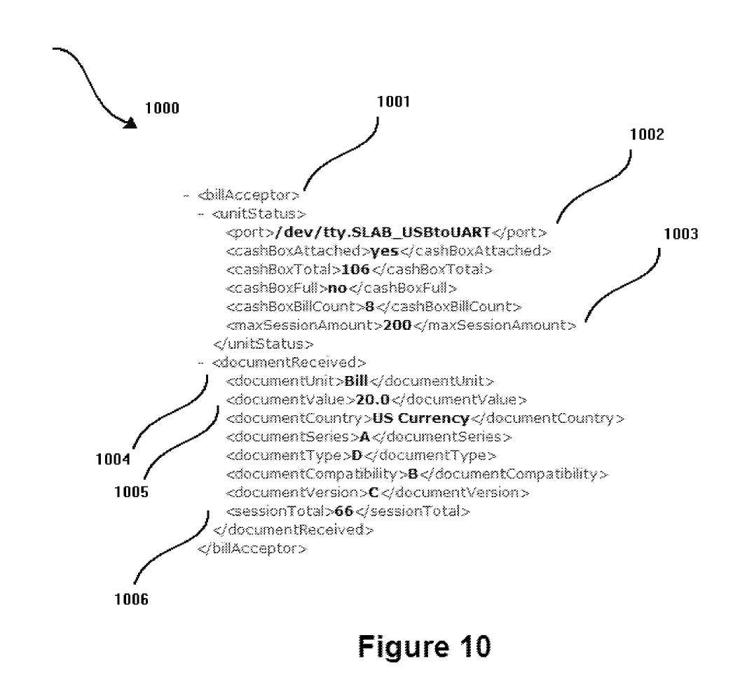

Referring now to FIG. 10, an example of a cash acceptor interface used for communication between the application layer 601 previously described in FIG. 6 and underlying interface services through the management interface 611 and further through the one or more interfaces such as the cash acceptor interface 606 among others not fully shown used in a system 1000 is described. The system 1000 including billAcceptor tags 1001 which may include a unitStatus block 1002 and may include a maxSessionAmount tag 1003 which may hold, for example, the maximum cash taken for a given transaction. The billAcceptor tag 1001 may further contain one or more documentReceived tags 1004 which may further detail the cash accepted, rejected, as well as others in one or more document detail tags 1005 including a sessionTotal tag 1006 which may contain the current session amount. These tags are created in response to counting monetary funds, accepting user account information and creating data messages to be transmitted to third party recipient institutions.

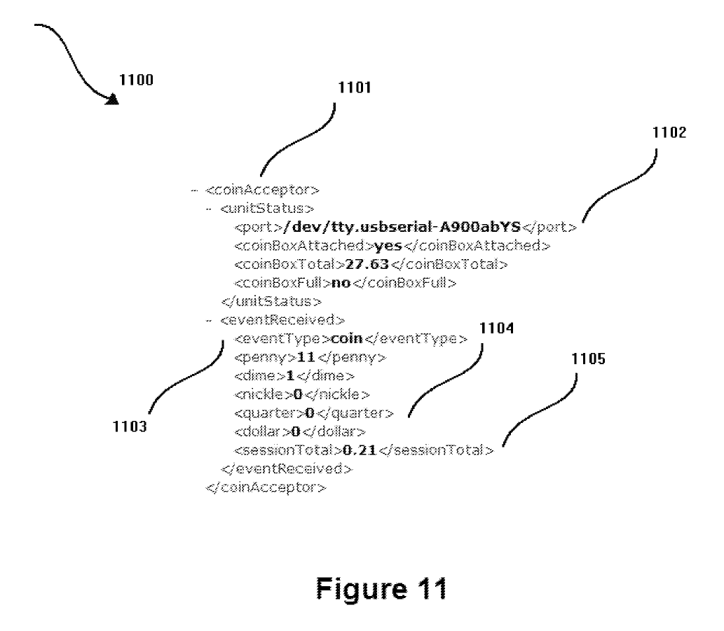

Referring now to FIG. 11, an example of a coin acceptor interface used for communication between the application layer 601 previously described in FIG. 6 and underlying interface services through the management interface 611 and further through the one or more interfaces such as the coin acceptor interface 609 among others not fully shown used in a system 1100 is described. The system 1100 includes coinAcceptor tags 1101 which may include a unitStatus block 1102. The coinAcceptor tag 1101 may further contain one or more eventReceived tags 1103 which may further detail the coin accepted, rejected, as well as others in one or more event detail tags 1104 including a sessionTotal tag 1105 which may contain the current session amount.

The coinAcceptor tags 1101 may be created at the beginning of the new user deposit transaction. The corresponding eventReceiver tags 1103 may be created subsequently to document the results of the deposit transaction and appended as a supplemental transaction tag to the primary transaction tag(s) that is transmitted to a remote third party financial institution. Tag creation of a first primary transaction tag may be supplemented by a subsequent supplemental transaction tag that is created after the primary transaction tag and either used as a subtractor or divider tag to modify a numerical value generated by the primary transaction tag (e.g., modifying an original dollar amount to remove values associated with rejected coins, dollars or coins exceeding a maximum deposit amount, etc.).

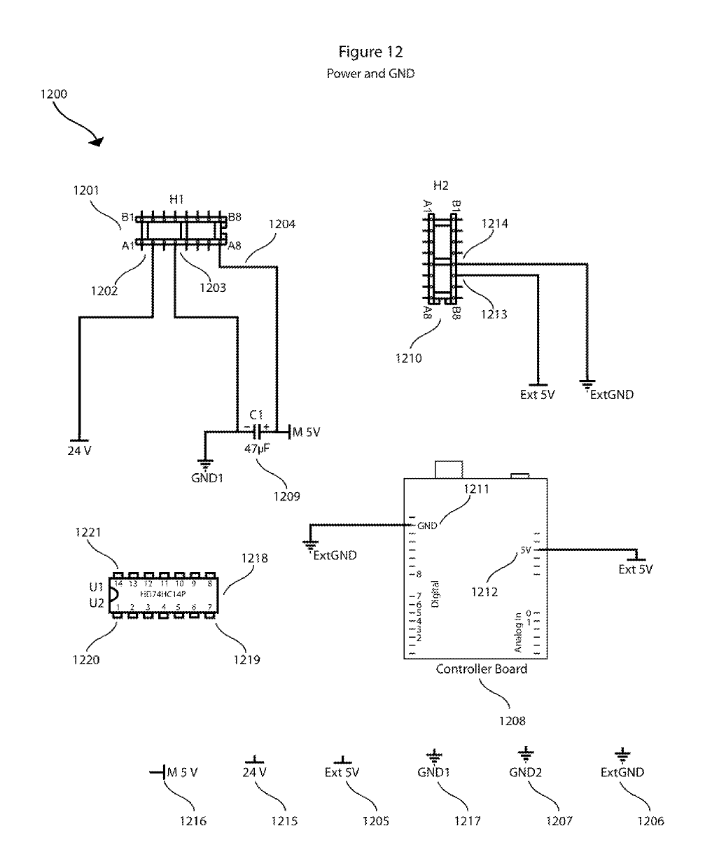

Referring now to FIG. 12, a 16-pin header 1201 is connected to the coin machine. A 24 volt DC power source 1215 is being supplied to the interface board through pin A2 1202. A 5 volt DC power source 1216 is supplied through pin A8 1204 for the purpose of powering IC chips and signal conditioning. Pin A8 1204 is connected to a coupling capacitor C1 1209 which then is connected to the coin machine ground GND1 1217 coming from pin A4 1203. Another 16-pin header 1210 connects the interface board to the Controller Board 1208. The Controller Board 1208 has its own ground called ExtGND 1206 located on pin 1211 that is connected to pin B5 1214 on header 1210. It also has its own 5 volt DC power source called EXT V5 1212 that is connected to pin B6 1213 on header 1210. The IC chips U1 1218 and U2 1218 are both powered the same way, they are two separate chips only displayed as one in this schematic. The 5 volt source 1216 powers the chips through pin 14 1221. Pins 1220 and 1219 are both connected to GND2 1207.

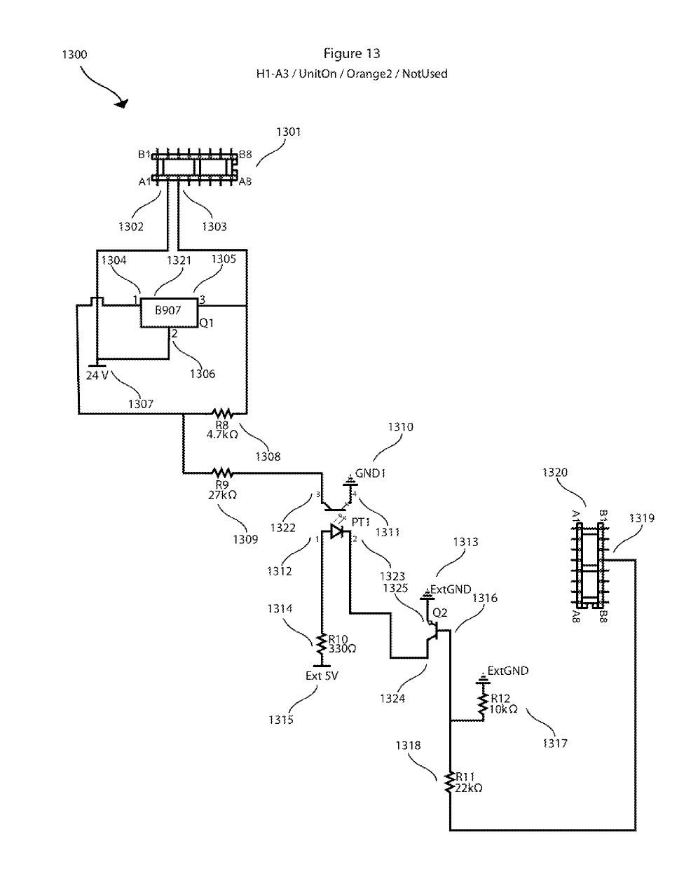

Referring now to FIG. 13. A 16-pin header 1320 connects the interface board to the Controller Board. The Controller Board sends a signal to turn the coin machine on or off through the B4 pin 1319 on header 1320. The signal travels to R11 1318, once it passes through 1318 it connects to both R12 1317 and the base pin of Q2 1316. R12 connects to ExtGND 1313. The emitter pin 1325 is connected to ExtGND 1313. The collector pin 1324 carries the signal to pin 2 1323 of the photo coupler. Pin 1 1312 of the photo coupler is connected to R10 1314 and R10 is connected to Ext 5V 1315. Pin 4 1311 of the photo coupler connects to GND1 1310. Pin 3 1322 of the photo coupler connects to R9 1309. R9 then connects to R8 1308 and pin 1 1304 of the Q1 voltage regulator 1321. When a signal is received at 1304 it triggers the Q1 transistor to short pin 2 1306 and pin 3 1305 together, turning the coin machine on. R8 1308 connects to pin 3 1305 of Q1 1321 and continues on to connect to A3 1303 on the 16-pin header 1301. Pin A2 1302 on the 16-pin header 1301 is connected to the coin machines 24 V DC 1307 and the connects to pin 2 1306 of Q1 1321.

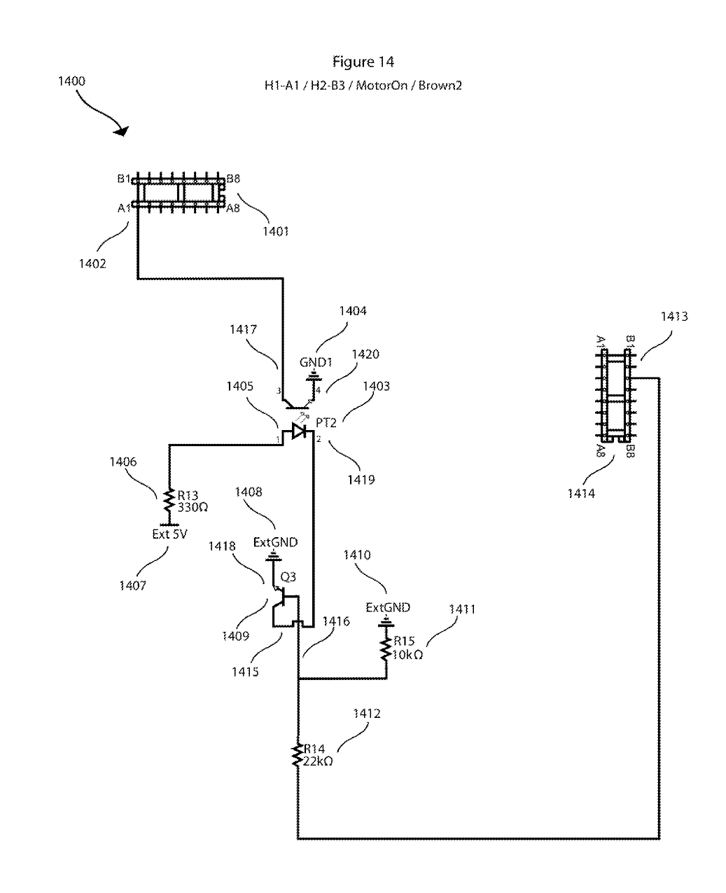

Referring now to FIG. 14. A 16-pin header 1414 connects the interface board to the Controller Board through pin B3 1413. The Controller Board sends a 200 ms 5 volt DC signal to pin 1413. The signal travels to R14 1412 where its voltage is conditioned. R14 1412 is connected to R15 1411 and also connected to the base pin 1416 on Q3 1409. R15 1411 is also connected to ExtGND 1410. This resistor 1411 is there to ensure that any unexpected high voltage spike will not damage the circuit. The emitter pin 1418 on transistor Q3 1409 is connected to ExtGND 1408. When the signal travels from 1416 to 1415 the signal is inverted. The collector pin 1415 on transistor Q3 1409 is connected to pin 2 1419 on the PT2 951 photo coupler 1403. Ext 5V 1407 connects to R13 1406 and 1406 conditions the 5 volts before it is received at pin 1 1405. Pin 4 1420 of PT2 1403 is connected to GND1 1404. When pin 2 1419 of 1403 receives the 0 volt low pulse, pin 3 1417 sends a low pulse to pin A1 1402 on header 1401. This low pulse signal turns the coin motor on, and it is sent every time the motor cycles until the Controller Board receives a STOP command from the PC. If the coin machine stops receiving the signal, the motor will cycle 3 times and turn off.

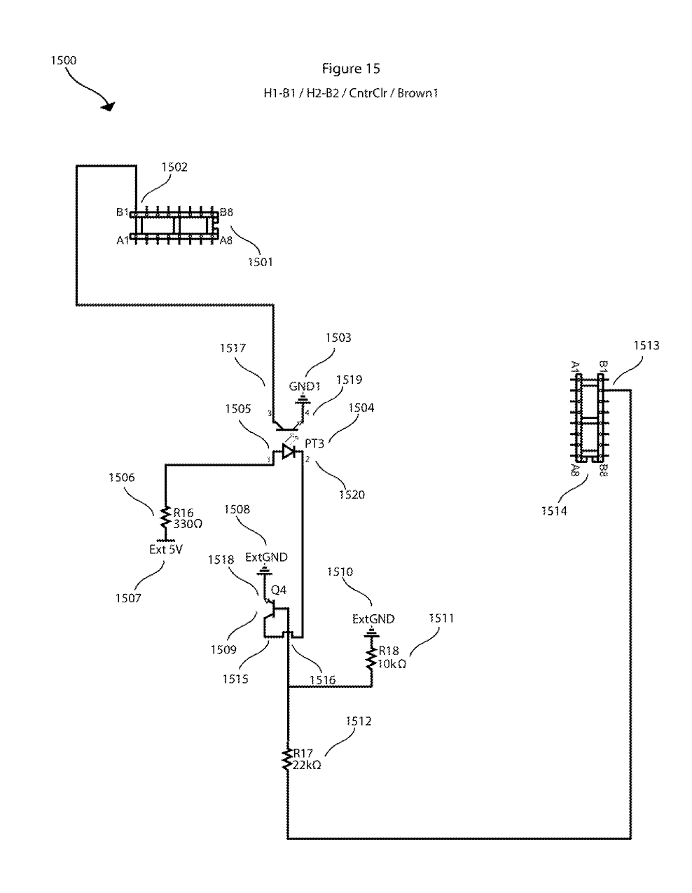

Referring now to FIG. 15. A 16-pin header 1514 connects the interface board to the Controller Board. The Controller Board sends a 1500 ms 5V DC pulse to pin B2 1513. This 5V pulse travels to R17 1512 where it is conditioned. 1512 connects to both R18 1511 and base pin 1516 of Q4 1509. R18 1511 is connected to ExtGND 1510 and it is used to ensure that any possible high voltage spike will not damage the circuit. Inside the transistor the signal is inverted and made a low pulse that is output through collector pin 1515. Emitter pin 1518 is connected to ExtGND 1508. The Ext 5V 1507 supplies a voltage to the PT3 photo coupler 1504, the voltage is first regulated with R16 1506. GND1 1503 is the ground of the PT3 photo coupler 1504 and is connected to pin 4 1519. The low pulse is received at pin 2 1520 on 1504 and the pin 3 1517 outputs the low pulse signal to pin B1 1502 on header 1501. This signal tells the machine to clear its counter. The digital signal must be maintained for at least 1500 ms to reset the counter.

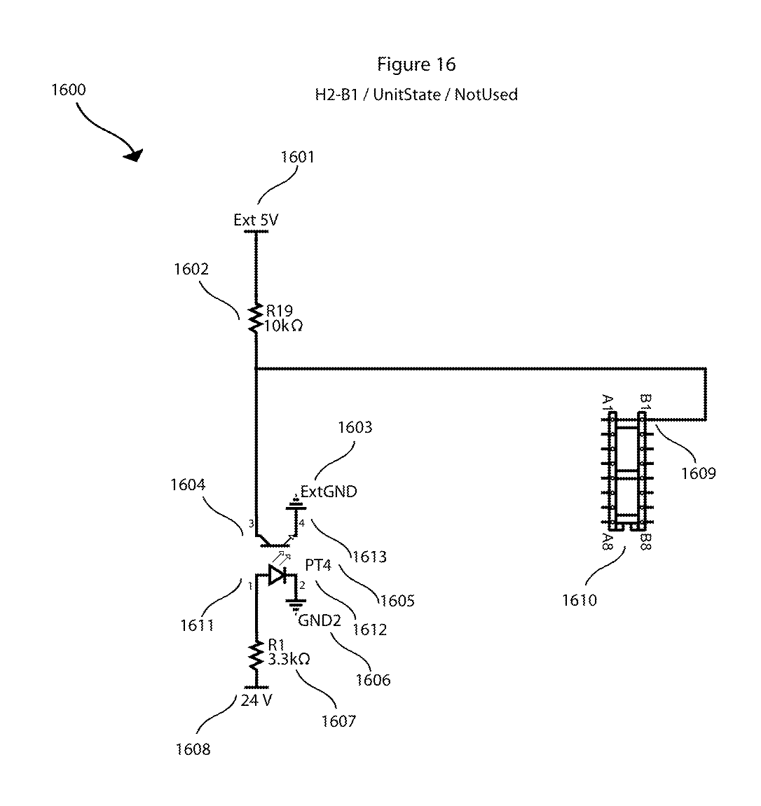

Referring now to FIG. 16. A 24V DC source 1608 is the machine power. It is connected through R1 1607 to pin 1 1611 of PT4 photo coupler 1605. Pin 2 1612 of 1605 is connected to GND2 1606. Pin 4 1613 of 1605 is connected to ExtGND 1603. Pin 3 1604 of 1605 is the output of the photo coupler. Ext 5v 1601 supplies a DC voltage for signal conditioning. The source is connected to R19 1602 and that resistor is used to signal conditioning. 1604 is connected to B1 1609 of header 1610 and R19 1602. A 16-pin header 1610 is connected to the Controller Board. The 24V source is only on if the machine is turned on. 1609 is the power indicator signal pin.

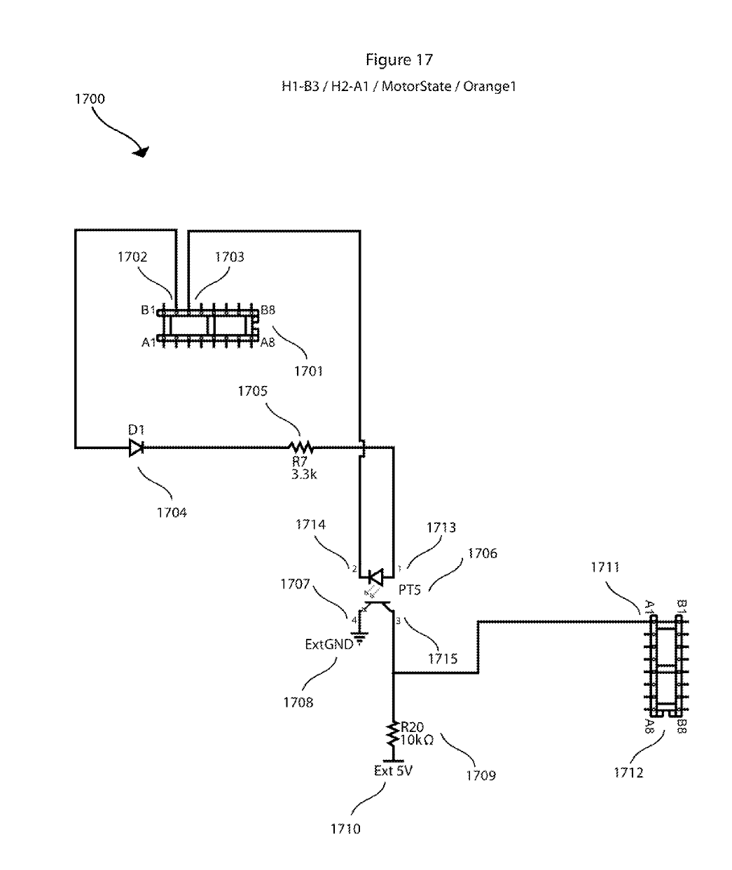

Referring now to FIG. 17. A 16-pin header 1701 connects the interface board to the coin machine. Pin B2 1702 is connected to the positive wire going to the coin machine motor. Pin B3 1703 is connected to the negative wire going to the count machine motor. Pin B2 1702 connects to diode D1 1704, the diode ensures that current will only be flowing one direction to protect the circuit and to minimize feedback. Diode D1 1704 is connected to R7 1705. R7 1705 then connects to pin 1 1713 on the PT5 photo coupler 1706. Pin B3 1703 connects directly to pin 2 1714 on photo coupler 1706. Pin 4 1707 on 1706 is connected to ExtGND 1708. Pin 3 1715 on 1706 is connected to R20 1709. 1709 connects to Ext 5V 1710. Pin 3 1715 on 1706 is also connected to pin A1 1711 on 16-pin header 1712. 1712 connects the interface board to the Controller Board. When the motor is running 1706 will be receiving 1 volt DC across pin 1 1713 and pin 2 1714. The photo coupler 1706 inverts the signal and amplifies it to 5 volts DC. Pin A1 1711 receives 5 volts DC when motor is not running, and it will drop to low state, 0 volts, when the motor is running.

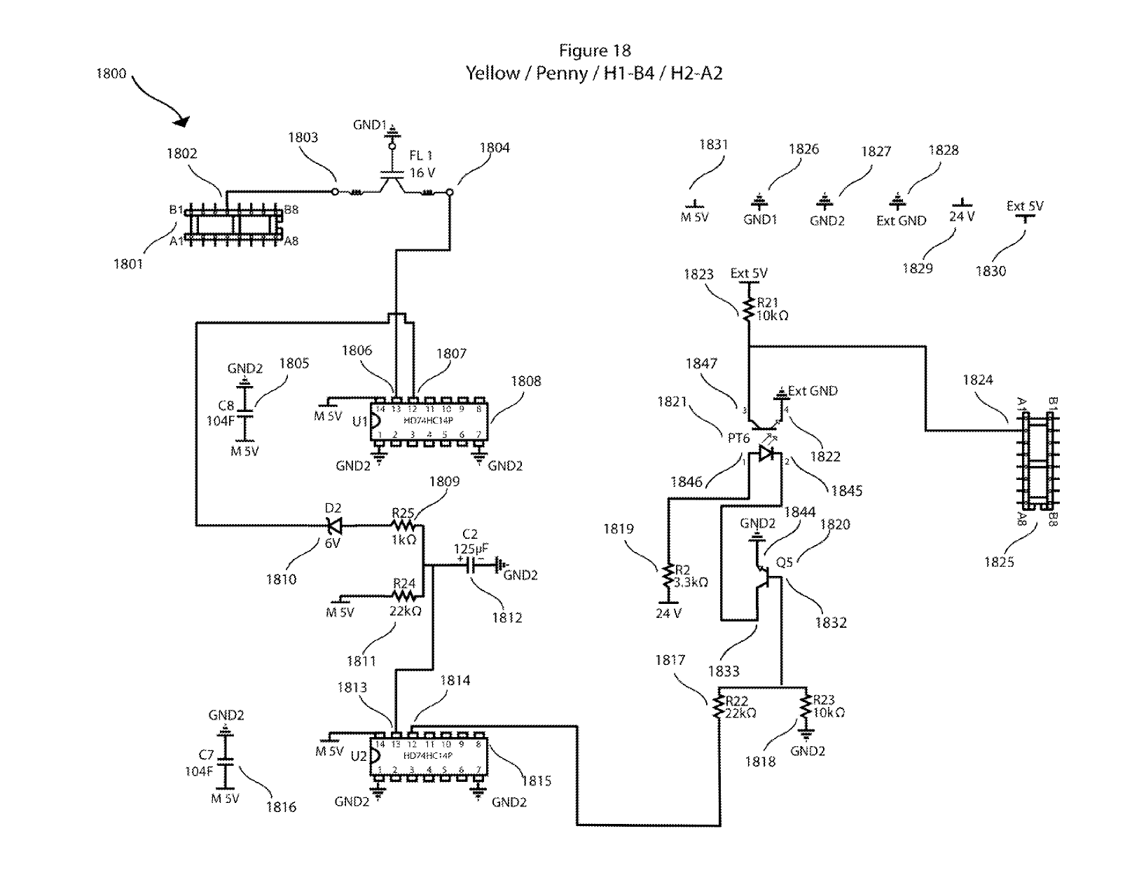

Referring now to FIG. 18. A 16-pin header 1801 connects the interface board to the coin machine. When a penny is read by the coin machine, it sends a signal to pin B4 1802. That signal then travels to an EMI suppression filter FL1 1803. The signal exits the filter at 1804 and travels to pin 13 1806 on the U1 HD74HC14P IC chip 1808. The signal gets inverted and exits at pin 12 1807 and travels to a Zener diode D2 1810. 1810 acts as a voltage regulator ensuring the voltage is safe for the circuit. The signal continues to R25 1809, after R25 it goes to R24 1811 and C2 1812. 1812 is grounded by GND2 1827. 1811 goes to m 5V 1831 a 5 volt source from the coin machine. The signal flows from a point between 1809, 1811, and 1812 to pin 13 1813 on the U2 HD74HC14P IC chip 1815. Here it is inverted again and exits at pin 12 1814 and travels to R22 1817. Continuing past R22 the signal goes to R23 1818 and Q5 1820. The other side of R23 1818 is GND2 1827. The signal enters Q5 1820 through the base pin 1832 and flows out the collector pin 1833 to pin 2 1845 on the PT6 photo coupler 1821. Pin 1 1846 on 1821 connects to R2 1819, then 1819 connects to a 24 volt DC power source 1829. Pin 4 1822 of 1821 connects to ExtGND 1828. Pin 3 1847 of 1821 connects to R21 1823 and pin A2 1824 from the 16-pin header 1825 which connects the interface board to the Controller Board. The grounds and sources used are M 5V 1831 a 5 volt source coming from the coin machine. GND1 1826 a ground from the coin machine, GND2 1827 an isolated ground from the interface board itself. Ext GND 1828 is a ground coming from the Controller Board. A 24V 1829 a 24 volt source from the coin machine. Ext 5V 1830 a 5 volt source from the Controller Board. A decoupling capacitor C8 1805 and C7 1816 minimize noise.

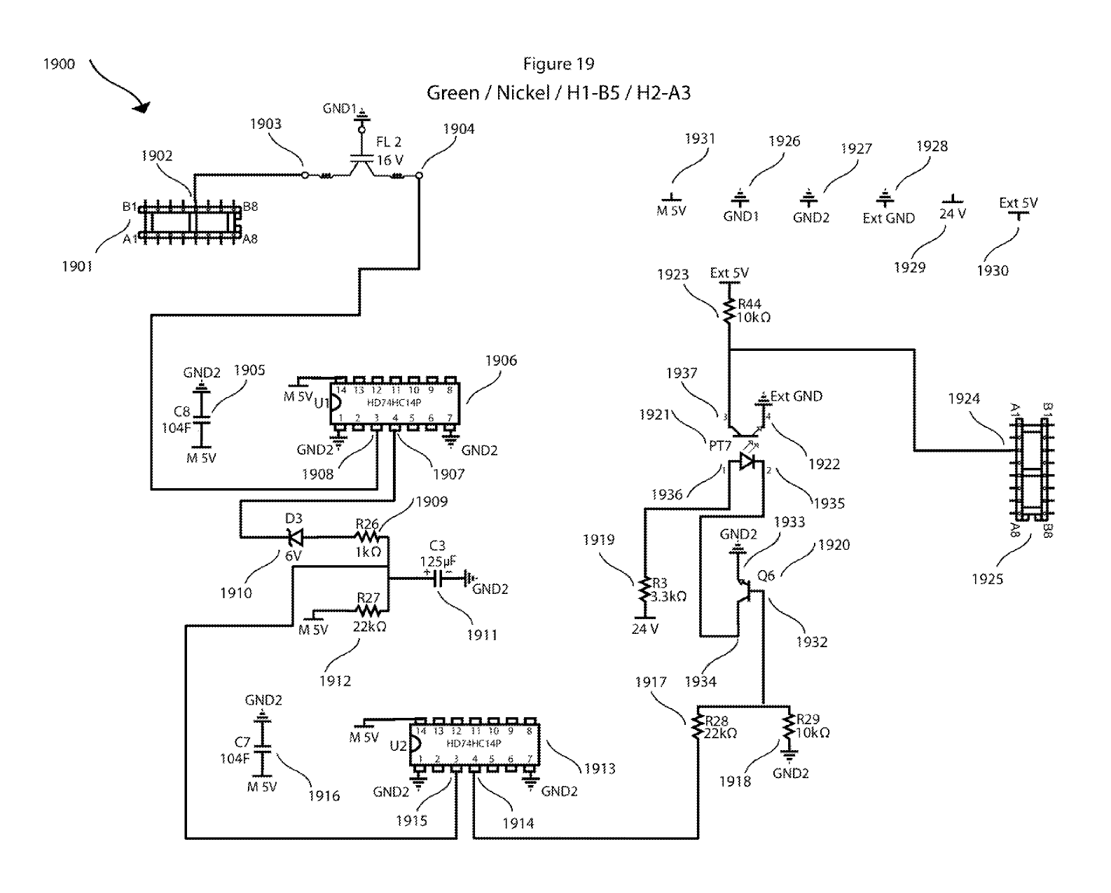

Referring now to FIG. 19. A 16-pin header 1901 connects the interface board to the coin machine. When a nickel is read by the coin machine, it sends a signal to pin B5 1902. That signal then travels to an EMI suppression filter FL2 1903. The signal exits the filter at 1904 and travels to pin 3 1908 on the U1 HD74HC14P IC chip 1906. The signal gets inverted and exits at pin 4 1907 and travels to a Zener diode D3 1910. 1910 acts as a voltage regulator ensuring the voltage is safe for the circuit. The signal continues to R26 1909, after R26 it goes to R27 1912 and C3 1911. 1911 is grounded by GND2 1927. 1912 goes to M 5V 1931 a 5 volt source from the coin machine. The signal flows from a point between 1909, 1911, and 1912 to pin 3 1915 on the U2 HD74HC14P IC chip 1913. Here it is inverted again and exits at pin 4 1914 and travels to R28 1917. Continuing past R28 the signal goes to R29 1918 and Q6 1920. The other side of R29 1918 is GND2 1927. The signal enters Q6 1920 through the base pin 1932 and flows out the collector pin 1934 to pin 2 1935 on the PT7 photo coupler 1921. Pin 1 1936 on 1921 connects to R3 1919, then 1919 connects to a 24 volt DC power source 1929. Pin 4 1922 of 1921 connects to ExtGND 1928. Pin 3 1937 of 1921 connects to R44 1923 and pin A3 1924 from the 16-pin header 1925 which connects the interface board to the Controller Board. The grounds and sources used are M 5V 1931 a 5 volt source coming from the coin machine. GND1 1926 a ground from the coin machine, GND2 1927 an isolated ground from the interface board itself. Ext GND 1928 is a ground coming from the Controller Board. 24V 1929 a 24 volt source from the coin machine. Ext 5V 1930 a 5 volt source from the Controller Board. A decoupling capacitor C8 1905 and C7 1916 minimizes noise.

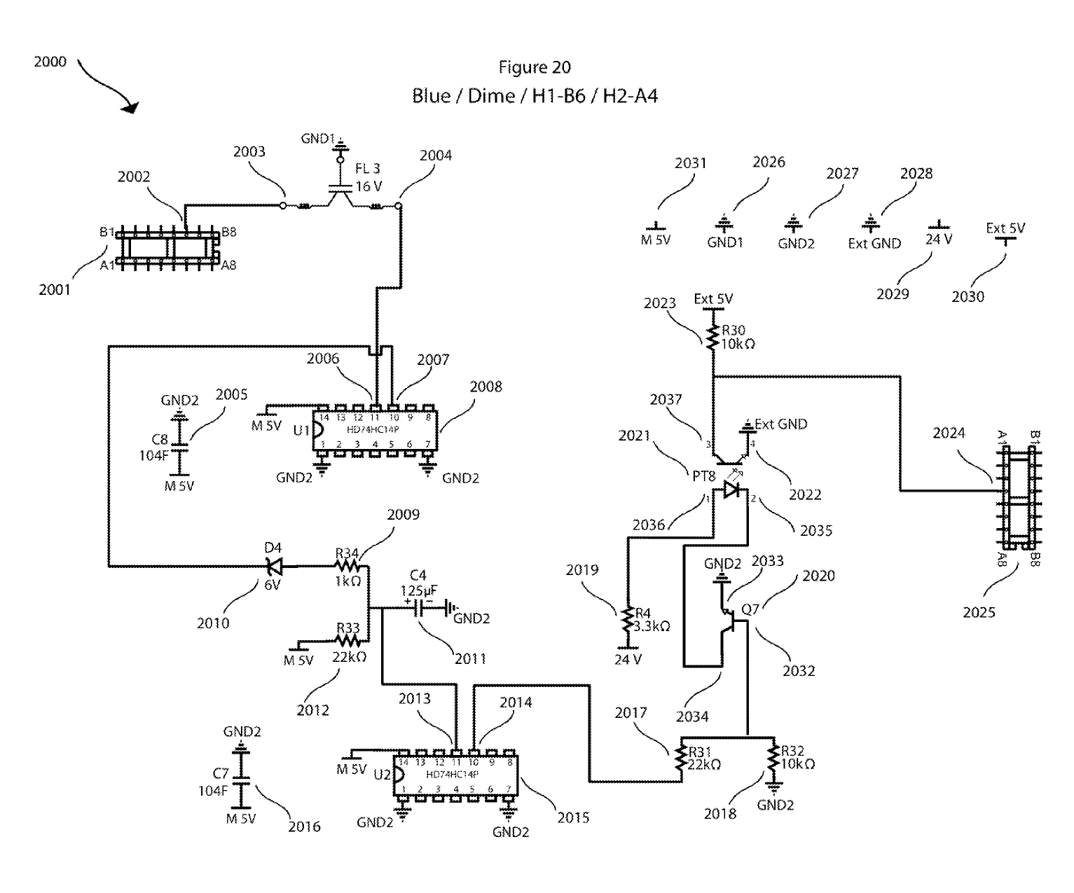

Referring now to FIG. 20. A 16-pin header 2001 connects the interface board to the coin machine. When a dime is read by the coin machine, it sends a signal to pin B6 2002. That signal then travels to an EMI suppression filter FL3 2003. The signal exits the filter at 2004 and travels to pin 11 2006 on the U1 HD74HC14P IC chip 2008. The signal gets inverted and exits at pin 10 2007 and travels to a Zener diode D4 2010. 2010 acts as a voltage regulator ensuring the voltage is safe for the circuit. The signal continues to R34 2009, after R34 it goes to R33 2012 and C4 2011. 2011 is grounded by GND2 2027. 2012 goes to M 5V 2031 a 5 volt source from the coin machine. The signal flows from a point between 2009, 2011, and 2012 to pin 11 2013 on the U2 HD74HC14P IC chip 2015. Here it is inverted again and exits at pin 10 2014 and travels to R31 2017. Continuing past R31 the signal goes to R32 2018 and Q7 2020. The other side of R32 2018 is GND2 2027. The signal enters Q7 2020 through the base pin 2032 and flows out the collector pin 2034 to pin 2 2035 on the PT8 photo coupler 2021. Pin 1 2036 on 2021 connects to R4 2019, then 2019 connects to a 24 volt DC power source 2029. Pin 4 2022 of 2021 connects to ExtGND 2028. Pin 3 2037 of 2021 connects to R30 2023 and pin A4 2024 from the 16-pin header 2025 which connects the interface board to the Controller Board. The grounds and sources used are M 5V 2031 a 5 volt source coming from the coin machine. GND1 2026 a ground from the coin machine, GND2 2027 an isolated ground from the interface board itself. Ext GND 2028 is a ground coming from the Controller Board. 24V 2029 a 24 volt source from the coin machine. Ext 5V 2030 a 5 volt source from the Controller Board. A decoupling capacitor C8 2005 and C7 2016 minimizes noise.

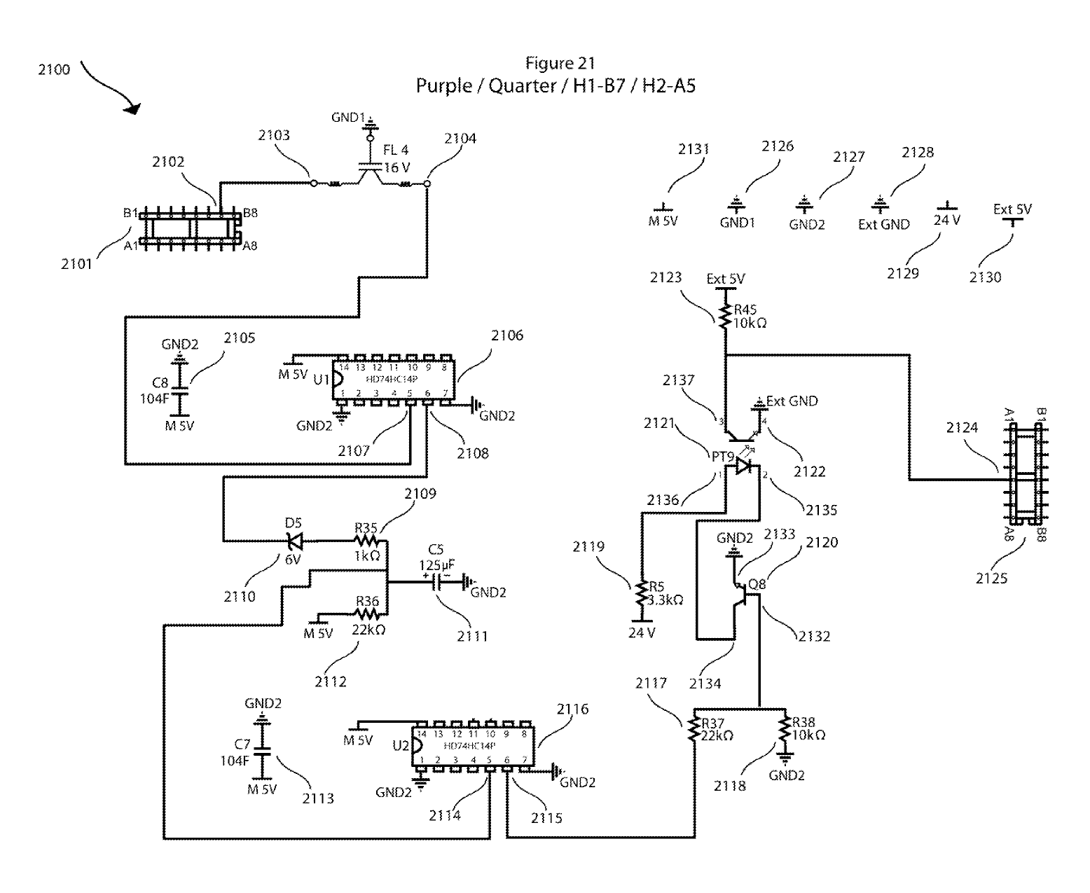

Referring now to FIG. 21. A 16-pin header 2101 connects the interface board to the coin machine. When a quarter is read by the coin machine, it sends a signal to pin B7 2102. That signal then travels to an EMI suppression filter FL4 2103. The signal exits the filter at 2104 and travels to pin 5 2107 on the U1 HD74HC14P IC chip 2106. The signal gets inverted and exits at pin 6 2108 and travels to a Zener diode D5 2110. 2110 acts as a voltage regulator ensuring the voltage is safe for the circuit. The signal continues to R35 2109, after R35 it goes to R36 2112 and C5 2111. 2111 is grounded by GND2 2127. 2112 goes to M 5V 2131 a 5 volt source from the coin machine. The signal flows from a point between 2109, 2111, and 2112 to pin 5 2114 on the U2 HD74HC14P IC chip 2116. Here it is inverted again and exits at pin 6 2115 and travels to R37 2117. Continuing past R37 the signal goes to R38 2118 and Q8 2120. The other side of R38 2118 is GND2 2127. The signal enters Q8 2120 through the base pin 2132 and flows out the collector pin 2134 to pin 2 2135 on the PT9 photo coupler 2121. Pin 1 2136 on 2121 connects to R5 2119, then 2119 connects to a 24 volt DC power source 2129. Pin 4 2122 of 2121 connects to ExtGND 2128. Pin 3 2137 of 2121 connects to R45 2123 and pin A5 2124 from the 16-pin header 2125 which connects the interface board to the Controller Board. The grounds and sources used are M 5V 2131 a 5 volt source coming from the coin machine. GND1 2126 a ground from the coin machine, GND2 2127 an isolated ground from the interface board itself. Ext GND 2128 is a ground coming from the Controller Board. 24V 2129 a 24 volt source from the coin machine. Ext 5V 2130 a 5 volt source from the Controller Board. A decoupling capacitor C8 2105 and C7 2113 minimizes noise.

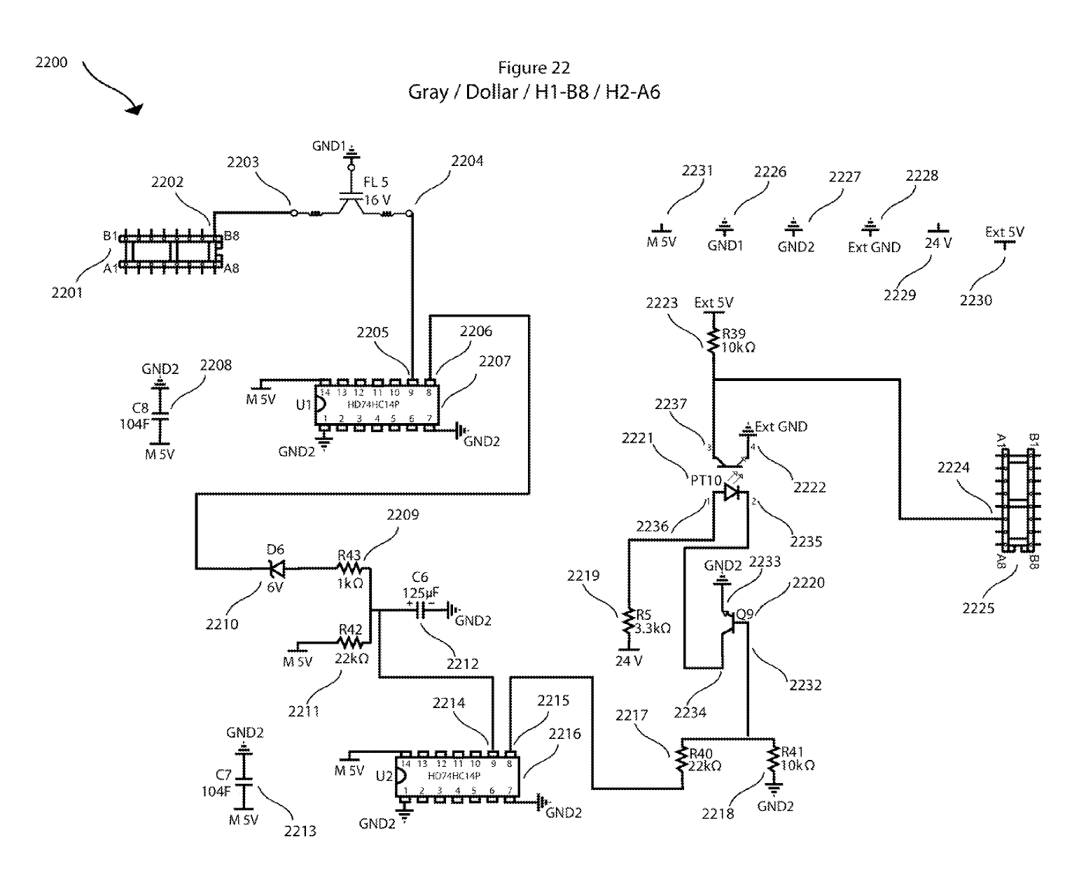

Referring now to FIG. 22. A 16-pin header 2201 connects the interface board to the coin machine. When a dollar coin is read by the coin machine, it sends a signal to pin B8 2202. That signal then travels to an EMI suppression filter FL5 2203. The signal exits the filter at 2204 and travels to pin 9 2205 on the U1 HD74HC14P IC chip 2207. The signal gets inverted and exits at pin 8 2206 and travels to a Zener diode D6 2210. 2210 acts as a voltage regulator ensuring the voltage is safe for the circuit. The signal continues to R43 2209, after R43 it goes to R42 2211 and C6 2212. 2212 is grounded by GND2 2227. 2211 goes to M 5V 2231 a 5 volt source from the coin machine. The signal flows from a point between 2209, 2211, and 2212 to pin 9 2214 on the U2 HD74HC14P IC chip 2216. Here it is inverted again and exits at pin 8 2215 and travels to R40 2217. Continuing past R40 the signal goes to R41 2218 and Q9 2220. The other side of R41 2218 is GND2 2227. The signal enters Q9 2220 through the base pin 2232 and flows out the collector pin 2234 to pin 2 2235 on the PT10 photo coupler 2221. Pin 1 2236 on 2221 connects to R6 2219, then 2219 connects to a 24 volt DC power source 2229. Pin 4 2222 of 2221 connects to ExtGND 2228. Pin 3 2237 of 2221 connects to R39 2223 and pin A6 2224 from the 16-pin header 2225 which connects the interface board to the Controller Board. The grounds and sources used are M 5V 2231 a 5 volt source coming from the coin machine. GND1 2226 a ground from the coin machine, GND2 2227 an isolated ground from the interface board itself. Ext GND 2228 is a ground coming from the Controller Board. 24V 2229 a 24 volt source from the coin machine. Ext 5V 2230 a 5 volt source from the Controller Board. A decoupling capacitor C8 2208 and C7 2213 minimizes noise in the circuit.

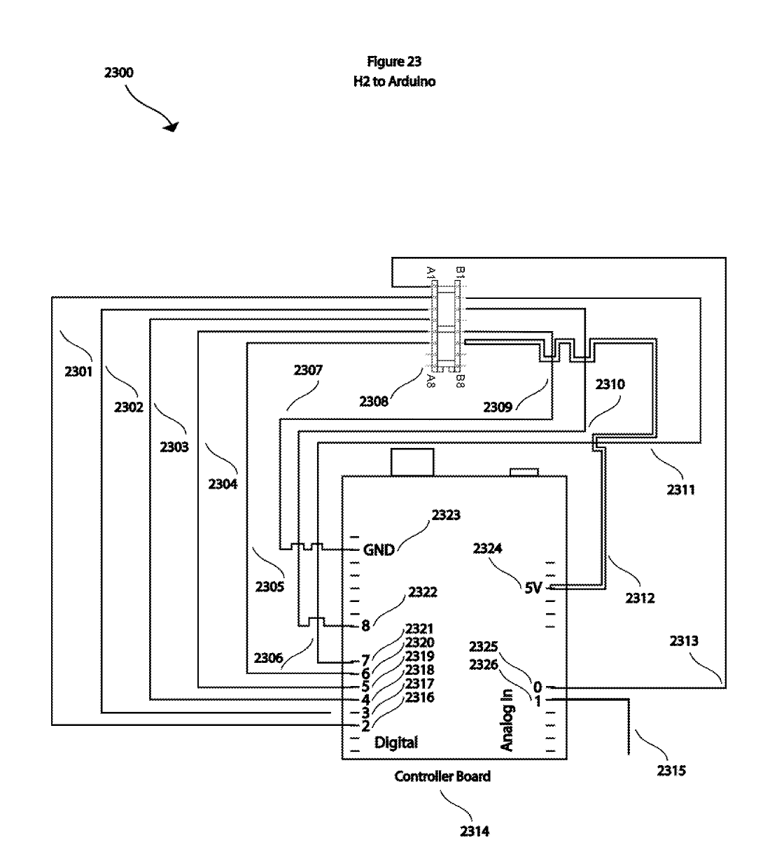

Referring now to FIG. 23. A 16-pin header 2308 connects the interface board with the Controller Board 2314. Pin A1 2313 from header 2308 carries the Motor State signal to the Analog 0 2325 on the Controller Board 2314. Pin A2 2301 header 2308 carries the Penny signal to the Digital 2 pin 2316 on the Controller Board 2314. Pin A3 2302 from header 2308 carries the nickel signal to Digital pin 3 2317 on the Controller Board 2314. Pin A4 2303 from header 2308 carries the dime signal to Digital pin 4 2318 on the Controller Board 2314. Pin A5 2304 from header 2308 carries the quarter signal to Digital pin 5 2319 on the Controller Board 2314. Pin A6 2305 from header 2308 carries the dollar coin signal to Digital pin 6 2320 on the Controller Board 2314. Pin B2 2311 from header 2308 carries the CntrClr (Clear Counter) signal to Digital pin 7 2321 on the Controller Board 2314. Pin B3 2310 from header 2308 carries the Motor On/Off signal to Digital pin 8 2322 on the Controller Board 2314. Pin B5 2309 from header 2308 connects to pin GND 2323 on the Controller Board 2314. Pin B5 2309 supplies the ground to the interface board. This ground is also called ExtGND. Pin B6 2312 from header 2308 connects to the pin 5V 2324 on the Controller Board 2314. Pin B6 2312 supplies 5 volts to the interface board, it referred to as Ext 5V. Pin 1 from the Controller Board 2326 connects to a magnetic proximity sensor.

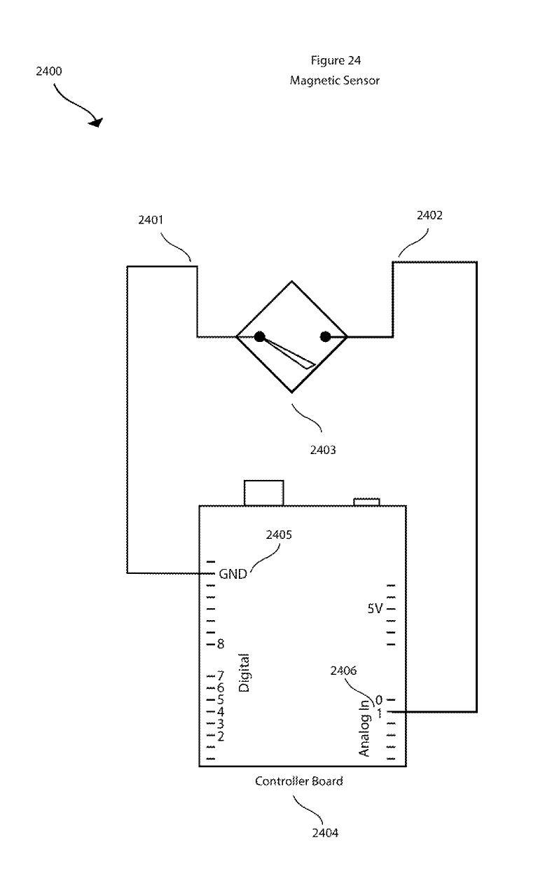

Referring now to FIG. 24. A magnetic proximity sensor 2403 is connected to the Controller Board 2404. Leg 2401 from the sensor 2403 connects to GND 2405 of the Controller Board 2404. Leg 2402 from the sensor 2403 connects to the Analog In pin 1 2406 of the Controller Board 2404.

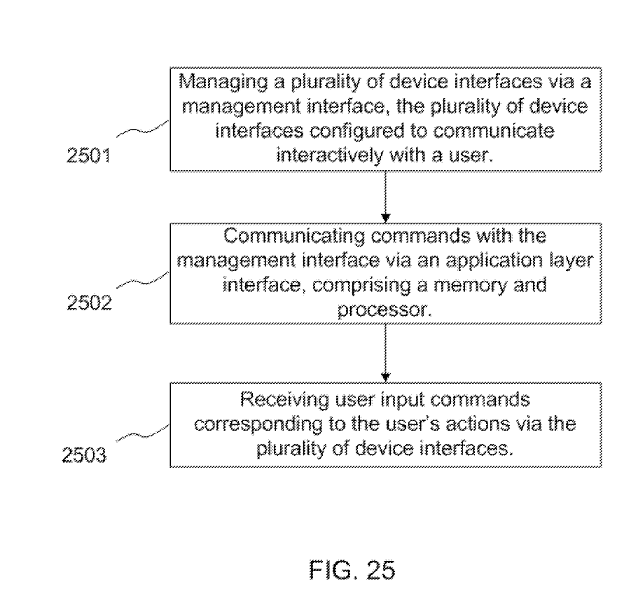

Referring now to FIG. 25, an example method of operation is disclosed. Referring to FIG. 25, the method provides managing a plurality of device interfaces via a management interface, the plurality of device interfaces configured to communicate interactively with a user, at operation 2501. The method further provides communicating commands with the management interface via an application layer interface including a memory and processor, the commands being communicated responsive to the user's interactive communication with the plurality of device interfaces, at operation 2502. The method also provides receiving user input commands corresponding to the user's actions via the plurality of device interfaces, at operation 2503.

In further detail, the plurality of device interfaces may be configured to provide data based on the user transaction both before, during and after the transaction. For instance, any tags created during the user transaction may be created and transmitted from each device interface to be concatenated in a data packet (e.g., tag1, tag2, tag3 . . . tag[n]) or to modify previously created tags in the tag sequence. The data that is created during the transaction may be formulated into data tags which include details of the user's personal information, monetary amounts of monies transacted, preferred financial institutions, etc. Each tag may represent a portion of the entire transaction data, and certain sub-tags may be used to modify existing tags. For example, a CurrentDepositAmount tag may be created and repeatedly modified by an UpdatedDepositAmount tag since the last update. In this case, the CurrentDepositAmount tag may be increased or decreased by the UpdatedDepositAmount tag and finalized when the transaction is complete. This tag and others created to represent the user's personal information, preferred financial institution, etc., may be used to create a multiple-tag packet or data message that is based on a plurality of different tags.

What is claimed is:

1. An apparatus comprising:
a plurality of device interfaces configured to communicate interactively with a user;
a management interface configured to manage the plurality of device interfaces; and
an application layer interface, comprising a memory and processor, configured to communicate commands with the management interface responsive to the user's interactive communication with the plurality of device interfaces, and wherein the plurality of device interfaces are configured to receive user input commands corresponding to the user's actions.

2. The apparatus of claim 1, wherein the plurality of device interfaces comprise at least one of:
a plurality of network connections;
a storage unit;
a display;
a camera;
a touch-screen display;
a keyboard;
a mouse;
a scanner;
a card reader;
a cash validator; and
a coin validator.

3. The apparatus of claim 1, wherein the user input commands are associated with at least one money transaction, and the corresponding communicated commands comprise at least one of: STARTCARD, STOPCARD, STARTCASH, HALTCASH, RESUMECASH, STOPCASH, STARTVIDEO, STOPVIDEO, STARTCOIN, and STOPCOIN.

4. The apparatus of claim 1, wherein the user's interaction with the plurality of device interfaces comprises a money deposit.

5. The apparatus of claim 4, wherein the user's interaction with the plurality of device interfaces comprises at least one of a video camera recording and a camera photograph of at least one dollar bill or check being deposited.

6. The apparatus of claim 1, wherein the user's interaction with the plurality of device interfaces comprises a coin deposit.

7. The apparatus of claim 6, wherein the user's interaction with the plurality of device interfaces comprises at least one of a coin acceptor interface configured to accept a coin deposit and create at least one event received tag indicating whether the at least one coin was accepted or rejected.

8. A method comprising:
managing a plurality of device interfaces via a management interface, the plurality of device interfaces configured to communicate interactively with a user; and
communicating commands with the management interface via an application layer interface, comprising a memory and processor, the commands being communicated responsive to the user's interactive communication with the plurality of device interfaces; and
receiving user input commands corresponding to the user's actions via the plurality of device interfaces.

9. The method of claim 8, wherein the plurality of device interfaces comprise at least one of:
a plurality of network connections;
a storage unit;
a display;
a camera;
a touch-screen display;
a keyboard;
a mouse;
a scanner;
a card reader;
a cash validator; and
a coin validator.

10. The method of claim 8, wherein the user input commands are associated with at least one money transaction, and the corresponding communicated commands comprise at least one of: STARTCARD, STOPCARD, STARTCASH, HALTCASH, RESUMECASH, STOPCASH, STARTVIDEO, STOPVIDEO, STARTCOIN, and STOPCOIN.

11. The method of claim 8, wherein the user's interaction with the plurality of device interfaces comprises a money deposit.

12. The method of claim 11, wherein the user's interaction with the plurality of device interfaces comprises at least one of a video camera recording and a camera photograph of at least one dollar bill or check being deposited.

13. The method of claim 8, wherein the user's interaction with the plurality of device interfaces comprises a coin deposit.

14. The method of claim 13, wherein the user's interaction with the plurality of device interfaces comprises at least one of a coin acceptor interface for accepting a coin deposit and creating at least one event received tag indicating whether the at least one coin was accepted or rejected.

15. A non-transitory computer readable storage medium comprising instructions that when executed cause a processor to perform:
managing a plurality of device interfaces via a management interface, the plurality of device interfaces configured to communicate interactively with a user; and
communicating commands with the management interface via an application layer interface, comprising a memory and processor, the commands being communicated responsive to the user's interactive communication with the plurality of device interfaces; and
receiving user input commands corresponding to the user's actions via the plurality of device interfaces.

16. The non-transitory computer readable storage medium of claim 15, wherein the plurality of device interfaces comprise at least one of:
a plurality of network connections;
a storage unit;
a display;
a camera;
a touch-screen display;
a keyboard;
a mouse;
a scanner;
a card reader;
a cash validator; and
a coin validator.

17. The non-transitory computer readable storage medium of claim 15, wherein the user input commands are associated with at least one money transaction, and the corresponding communicated commands comprise at least one of: STARTCARD, STOPCARD, STARTCASH, HALTCASH, RESUMECASH, STOPCASH, STARTVIDEO, STOPVIDEO, STARTCOIN, and STOPCOIN.

18. The non-transitory computer readable storage medium of claim 15, wherein the user's interaction with the plurality of device interfaces comprises a money deposit.

19. The non-transitory computer readable storage medium of claim 18, wherein the user's interaction with the plurality of device interfaces comprises at least one of a video camera recording and a camera photograph of at least one dollar bill or check being deposited.

20. The non-transitory computer readable storage medium of claim 15, wherein the user's interaction with the plurality of device interfaces comprises a coin deposit.
